(19) United States
(12) Patent Application Publication
(10) Pub. No.: US 2011/0093156 A1
(43) Pub. Date: Apr. 21, 2011

(54) UNIT FOR DISPLAYING ACCELERATION FOR TRAVELING APPARATUS

(76) Inventors: Hyung-Rok LEE, Goyang-si (KR); Seung-Hee LEE, Goyang-si (KR)

(21) Appl. No.: 12/908,044

(22) Filed: Oct. 20, 2010

(30) Foreign Application Priority Data
Oct. 21, 2009 (KR) 10-2009-0100356
Aug. 23, 2010 (KR) 10-2010-0081438

(51) Int. Cl. G06F 7/00

(52) U.S. Cl. 701/29

(57) ABSTRACT

Provided is a unit for displaying acceleration for a traveling apparatus. The unit for displaying acceleration for a traveling apparatus includes a sensor installed on an acceleration pedal operating to control a traveling speed of the traveling apparatus, and sensing operation of the acceleration pedal to transmit electric signal to the outside, and a light emission control module installed in the traveling apparatus, receiving the electric signal from the sensor and controlling light emission of one or a plurality of first lamps installed around taillights of the traveling apparatus. Therefore, when a driver presses an acceleration pedal while driving a traveling apparatus, an acceleration state of the traveling apparatus may be displayed to the outside to inform the state.

### CROSS-REFERENCE TO RELATED APPLICATION

This application claims priority under 35 U.S.C. §119 to Korean Patent Application Nos. 10-2009-0100356 filed on Oct. 21, 2009 and 10-2010-0081438 filed on Aug. 23, 2010, the disclosure of which is hereby incorporated by reference in its entirety.

### BACKGROUND

1. Field

Embodiments of the present invention relate to a unit for displaying acceleration for a traveling apparatus, and more specifically, to a unit for displaying acceleration for a traveling apparatus capable of displaying an acceleration state of the traveling apparatus to the outside to inform the state when a driver presses an accelerator.

2. Description of Related Art

In a conventional traveling apparatus such as a car, when a driver presses an accelerator pedal by a predetermined amount, the accelerator pedal rotates with respect to an axis by a predetermined angle, and thus a cable installed between a top end part of the accelerator pedal and a throttle valve of an engine is pulled as much as the length corresponding to the rotation amount of the accelerator pedal, so that the throttle valve is opened as much as the corresponding length to accelerate the number of revolutions of the engine.

Also, when the driver releases the pressed accelerator pedal by a predetermined amount, a restoring force of a return spring installed in the acceleration pedal and the throttle valve may enable the pedal to be restored to the original state as much as a predetermined angle. Therefore, a cable moves towards the acceleration pedal as long as a predetermined length, and at the same time, the throttle valve of an engine is closed in response thereto, so that the number of rotations of the engine may be reduced.

Such a process is repeated to correspond to an amount of rotation orbits of the acceleration pedal operated by the driver, so that the car reduces the speed.

Traveling apparatuses that reduce the speed in the above manner travel on a road, and only a stop light informing braking operation that is used in reducing a speed is installed at a rear side of a conventional traveling apparatus.

Therefore, when a conventional traveling apparatus increases speed using a acceleration pedal, drivers of other traveling apparatuses are not able to visibly recognize the state. Accordingly, a technique in which a driver of a front car (or a traveling apparatus) uses an acceleration pedal during night drive to enable drivers of other traveling apparatuses to easily recognize an acceleration state of the car, so that a vehicle collision may be prevented in advance is required.

### SUMMARY

Embodiments of the present invention provide a unit for displaying acceleration for a traveling apparatus capable of informing an acceleration state of the traveling apparatus to the outside when a driver presses an acceleration pedal while driving a traveling apparatus.

Embodiments of the present invention provide a unit for displaying acceleration for a traveling apparatus capable of informing presence of acceleration of the apparatus to other traveling apparatuses following behind a rear end thereof to prevent a negligent accident such as a vehicle collision in advance.

In accordance with an aspect of the present invention, a unit for displaying acceleration for a traveling apparatus is provided.

The unit for displaying acceleration for a traveling apparatus includes: a sensor installed on an acceleration pedal operating to control a traveling speed of the traveling apparatus, and sensing operation of the acceleration pedal to transmit electric signal to the outside; and a light emission control module installed in the traveling apparatus, receiving the electric signal from the sensor and controlling light emission of one or a plurality of first lamps installed around taillights of the traveling apparatus.

Here, the acceleration pedal may include a rotation axis installed in the traveling apparatus, an operating bar rotatably connected to the rotation axis and having one end connected to a throttle valve installed in a power generation engine of the traveling apparatus via a wire, and a paddle installed on the other end of the operating bar and applied by external power.

The light emission control module may include: the one or plurality of first lamps disposed between the taillights disposed at both sides of a rear part of the traveling apparatus; and a controller electrically connected to the one or plurality of first lamps and causing the one or plurality of first lamps to emit light in response to the electric signal output from the sensor.

The light emission control module may further include a variable controller controlling the controller to adjust an amount of light emission of the one or plurality of first lamps in response to the electric signal output from the sensor.

The light emission control module may further include a speed measurement part installed in the traveling apparatus, measuring a variable traveling speed of the traveling apparatus, and transmitting the results to the controller.

The one or plurality of first lamps may include a plurality of groups emitting different lights, and the light emission control module may further include a lamp selector optionally selecting one or a plurality of groups of the plurality groups depending on control of the controller.

The light emission control module may include a plurality of second lamps consisting of a plurality of groups such that figures are displayed, and the lamp selector may optionally select one or a plurality of groups of the plurality of groups depending on control of the controller such that the plurality of second lamps display a variable traveling speed of the traveling apparatus in figures.

The sensor may be installed in the paddle, sense a change in pressure applied to the paddle, and transmit the electric signal.

The sensor may be a rotation angle detection sensor installed on the rotation axis, and sensing a rotation angle of the operating bar to transmit the electric signal.

### BRIEF DESCRIPTION OF THE DRAWINGS

The foregoing and other features and advantages of the present invention will be apparent from the more particular description of exemplary embodiments of the present invention, as illustrated in the accompanying drawings in which like reference characters refer to the same parts throughout the different views. The drawings are not necessarily to scale, emphasis instead being placed upon illustrating the principles of the present invention. In the drawings:

FIG. 1 is a view of a traveling apparatus in which a unit for displaying acceleration for a traveling apparatus of the present invention is installed;

FIG. 2 is a view of a rear side of the traveling apparatus of FIG. 1;

FIG. 3 is a view illustrating one example of disposition of a lamp according to the present invention;

FIG. 4 is a view illustrating another example of disposition of a lamp according to the present invention;

FIG. 5 illustrated an example of a unit for displaying acceleration for a traveling apparatus of the present invention;

FIG. 6 is a flowchart of a configuration of the unit for displaying acceleration for a traveling apparatus of FIG. 5;

FIG. 7 is a view illustrating an example of a unit for displaying acceleration for a traveling apparatus of the present invention;

FIG. 8 is a block diagram illustrating a configuration of the unit for displaying acceleration for a traveling apparatus of FIG. 7;

FIG. 9 is a view illustrating an example of a unit for displaying acceleration for a traveling apparatus of the present invention;

FIG. 10 is a block diagram illustrating a configuration of the unit for displaying acceleration for a traveling apparatus of FIG. 9;

FIG. 11 is a block diagram of a plurality of optionally selected lamps according to the present invention; and

FIGS. 12 and 13 are views illustrating a still another example in which a lamp is disposed according to the present invention.

### DETAILED DESCRIPTION OF THE EMBODIMENTS

Various exemplary embodiments will now be described more fully with reference to the accompanying drawings in which some exemplary embodiments are shown. This present invention may, however, be embodied in different forms and should not be construed as limited to the exemplary embodiments set forth herein. Rather, these exemplary embodiments are provided so that this disclosure is thorough and complete and fully conveys the scope of the present invention to one skilled in the art. In the drawings, the thickness of layers and regions may be exaggerated for clarity. Also, when it is referred that a layer is “on” another layer or a substrate, it may be directly formed on another layer or the substrate or a third layer may be interposed therebetween. Like reference numerals designate like elements throughout the specification.

A unit for displaying acceleration for a traveling apparatus of the present invention will be described below with reference to the accompanying drawings.

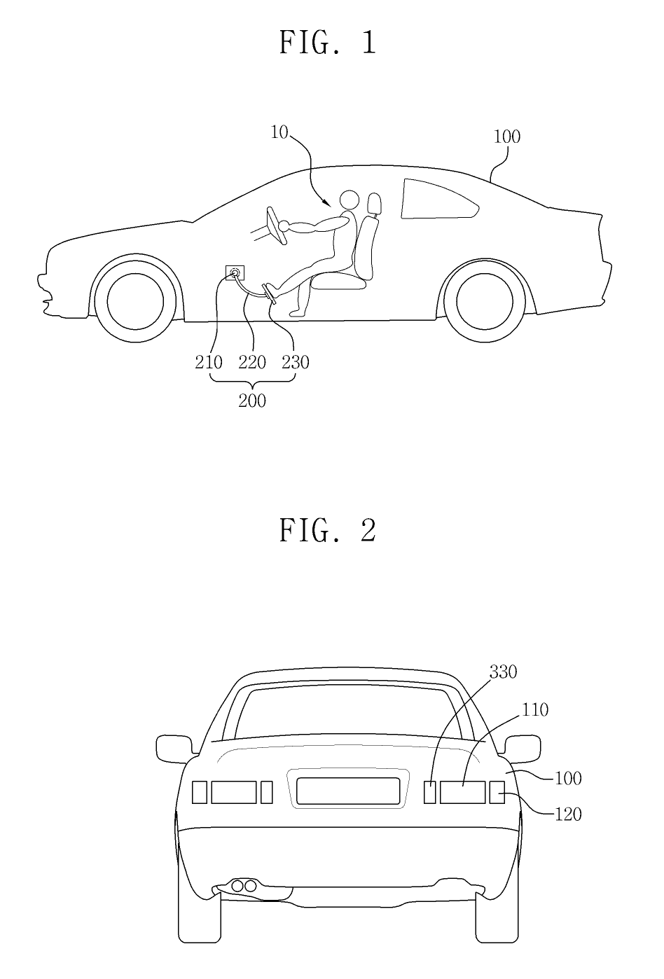

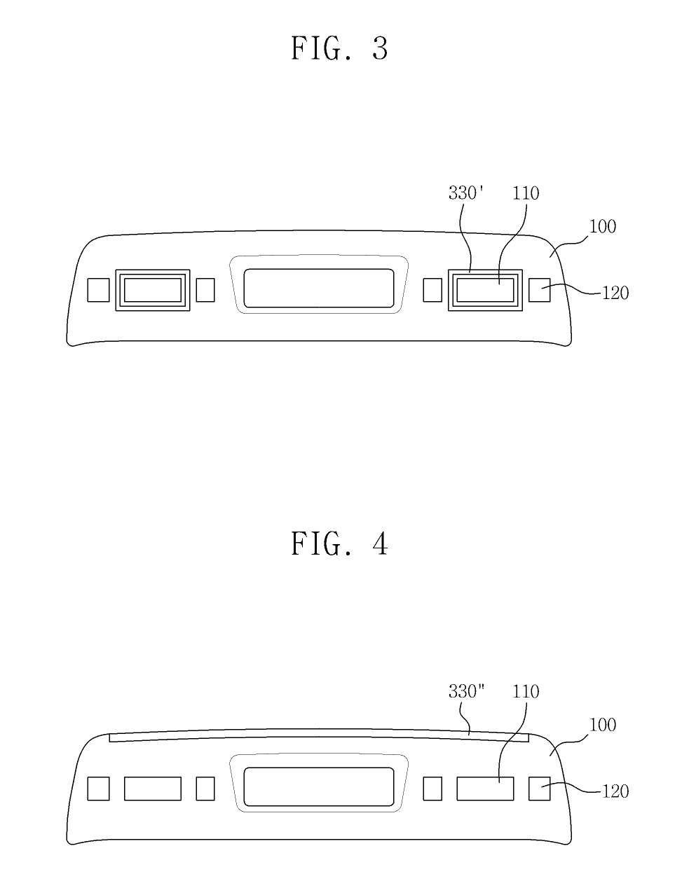

FIG. 1 is a view of a traveling apparatus in which a unit for displaying acceleration for a traveling apparatus of the present invention is installed. FIG. 2 is a view of a rear side of the traveling apparatus of FIG. 1. FIG. 3 is a view illustrating one example of disposition of a lamp according to the present invention. FIG. 4 is a view illustrating another example of disposition of a lamp according to the present invention.

Referring to FIG. 1, the unit for displaying acceleration for a traveling apparatus of the present invention includes a sensor installed on an acceleration pedal 200 operating to control a traveling speed of a traveling apparatus 100, and sensing operation of the acceleration pedal 200 to transmit electric signal to the outside, and a light emission control module 300 installed in the traveling apparatus, and receiving an electric signal from the sensor to control light emission of lamps installed around taillights of the traveling apparatus.

The traveling apparatus 100 may be an apparatus such as a car, and may include an engine, and a power transmission part transmitting power to the engine.

Further, the acceleration pedal 200 includes a rotation axis 210 installed in the traveling apparatus 100, an operating bar 220 rotatably connected to the rotation axis 210, and having one end connected to a throttle valve installed on a power generation engine of the traveling apparatus 100 via a wire, and a paddle 230 installed on the other end of the operating bar 220, and applied by external power.

Here, the operating bar 220 is connected to the throttle valve via a wire to control the degree of open and close of the throttle valve installed on the engine. Depending on rotation of the operating bar 220, the degree of pulling of the wire is determined, and as a result, the degree of acceleration of the traveling apparatus via the engine is determined.

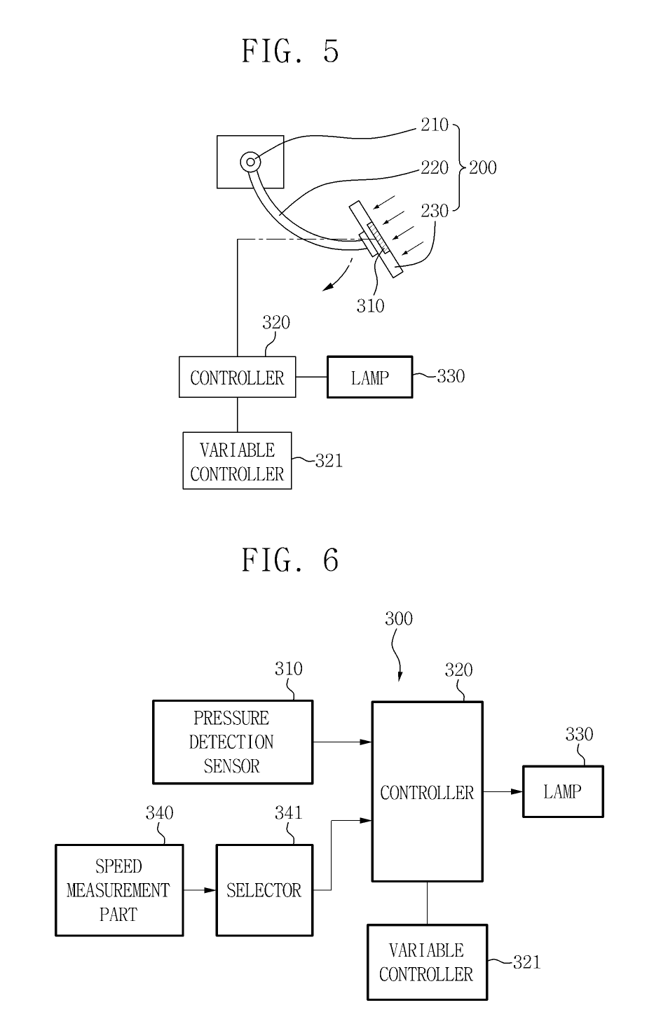

FIG. 5 illustrated an example of a unit for displaying acceleration for a traveling apparatus of the present invention. FIG. 6 is a flowchart of a configuration of the unit for displaying acceleration for a traveling apparatus of FIG. 5.

One example of the unit for displaying acceleration for a traveling apparatus of the present invention will be described with reference to FIGS. 5 and 6.

The sensor is installed in the paddle 230, and is a pressure detection sensor 310 detecting a change in pressure applied to the paddle 230. The pressure detection sensor 310 is installed in the paddle 230 such that its surface is exposed. The paddle 230 is a device by which a driver is able to directly apply pressure, and when the driver presses a surface of the paddle 230 using his/her foot, the pressure detection sensor 310 may measure the degree of the applied pressure.

Further, the light emission control module 300 includes a lamp 330 installed at a rear part of the traveling apparatus 100, and a controller 320 electrically connected to the lamp 330 and receiving the variable pressure from the pressure detection sensor 310 to cause the lamp 330 to emit light.

Therefore, when the driver presses the paddle 230 using his/her foot, at least a predetermined pressure level acts upon the surface of the paddle 230. Here, the pressure detection sensor 310 installed in the paddle 230 is able to sense the acted pressure, and transmits the sensed results to the controller 320. Further, the controller 320 lights the lamp 330.

Furthermore, the pressure detection sensor 310 senses the variable pressure sensed by the paddle 230 to transmit the results to the controller 320.

Here, since the controller 320 may further include a variable controller 321 such as variable resistance, the controller 320 may control an amount of light emission of the lamp 330 to be proportional to the variable pressure. For example, when the pressure sensed by the paddle 230 is increased, the amount of light emission of the lamp 330 may be increased. Here, since the speed of the traveling apparatus 100 is accelerated depending on degree of pressure applied to the paddle 230, the amount of light emission of the lamp 330 may represent the speed of the traveling apparatus 100 in an indirect manner

Accordingly, other traveling apparatuses traveling behind the rear part of the traveling apparatus 100 may easily and visibly determine whether the traveling apparatus 100 increases speed or reduces speed depending on an amount of light emission of the lamp 330.

In addition, the controller 320 may be further electrically connected to a selector 341, and the selector 341 may be further connected to a speed measurement part 340.

Here, the speed measurement part 340 may be a speedometer installed in the traveling apparatus 100 such as a car, and a speed measurement program employed by a navigation system.

When use of the speed measurement part 340 is selected by the selector 341, the speed measurement part 340 may transmit a measure traveling speed of the traveling apparatus 100 to the controller 320.

Further, the controller 320 may adjust the amount of light emission of the lamp 330 to be proportional to the traveling speed.

Accordingly, whether the traveling apparatus 100 increases speed or not may be visibly determined depending on degree of the amount of light emission of the lamp 330 installed at the rear end of the traveling apparatus 100.

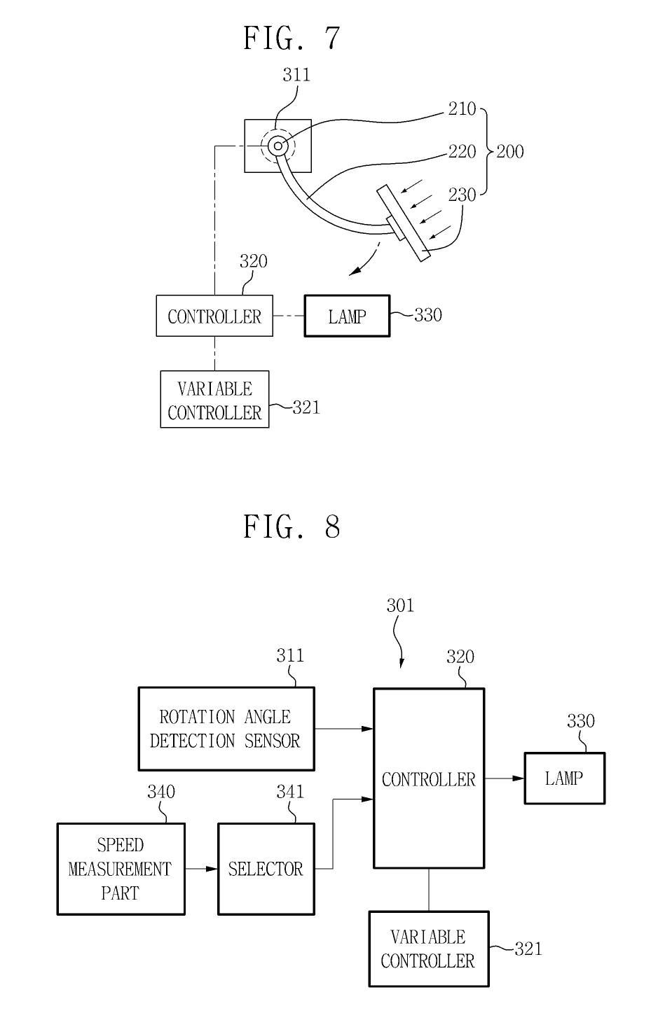

FIG. 7 is a view illustrating an example of a unit for displaying acceleration for a traveling apparatus of the present invention. FIG. 8 is a block diagram illustrating a configuration of the unit for displaying acceleration for a traveling apparatus of FIG. 7.

Next, a unit for displaying acceleration for a traveling apparatus according to another exemplary embodiment of the present invention will be described below with reference to FIGS. 7 and 8.

The sensor may be installed on the rotation axis 210, and may be a rotation angle detection sensor 311 sensing a rotation angle of the operating bar 220.

In addition, a light emission control module 301 may include a controller 320 having the lamp 330, and a variable controller 321 electrically connected to the lamp 330, receiving the variable rotation angle from the rotation angle detection sensor 311 and controlling the amount of light emission of the lamp 330 to be proportional to the amount of light emission of the lamp 330 depending on the variable rotation angle.

Here, the controller 320 may be include a variable controller 321 electrically connected to the speed measurement part 340 installed in the traveling apparatus 100 to measure a variable traveling speed of the traveling apparatus 100, and receiving the variable traveling speed from the speed measurement part 340 to control the amount of light emission of the lamp 330 to be proportional to the variable traveling speed.

Also, when the controller 320 receives a selected signal via the selector 341 electrically connected thereto, it may control the amount of light emission of the lamp 330 to be proportional to the variable traveling speed.

Therefore, when a driver presses the paddle 230 using his/her foot, the operating bar 220 of the acceleration pedal 200 rotates with respect to the rotation axis 210.

Here, the rotation angle detection sensor 311 installed on the rotation axis 210 detects a rotation angle of the operating bar 220, and transmits the results to the controller 320. Further, the controller 320 causes the lamp 330 to be lit.

Furthermore, the rotation angle detection sensor 311 detects the variable rotation angle to transmit the results to the controller 320.

Here, since the controller 320 further includes a variable controller 321 such as variable resistance, it may control an amount of light emission of the lamp 330 to be proportional to the variable rotation angle. For example, when a rotation angle is increased in the original location of the operating bar 220, the amount of light emission of the lamp 330 may be increased. Here, since the speed of the traveling apparatus 100 is accelerated depending on degree of a rotation angle of the operating bar 220, the amount of light emission of the lamp 330 may represent the speed of the traveling apparatus 100 in an indirect manner.

Accordingly, other traveling apparatuses traveling behind the rear end of the traveling apparatus 100 may easily and visibly determine whether the traveling apparatus 100 increases speed or not depending on degree of an amount of variable light emission of the lamp 330.

Moreover, the controller 320 may be further electrically connected to the selector 341, and the selector 341 may be further connected to the speed measurement part 340.

Here, the speed measurement part 340 may be a speedometer installed in the traveling apparatus 100 such as a car or a speed measurement program employed by a navigation system.

When use of the speed measurement part 340 is selected by the selector 341, the speed measurement part 340 may transmit a measured traveling speed of the traveling apparatus 100 to the controller 320.

Further, the controller 320 may adjust the amount of light emission of the lamp 330 to be proportional to the traveling speed.

Accordingly, whether the traveling apparatus 100 increases speed or not may be visibly determined depending on degree of the amount of light emission of the lamp 330 installed at the rear end of the traveling apparatus 100.

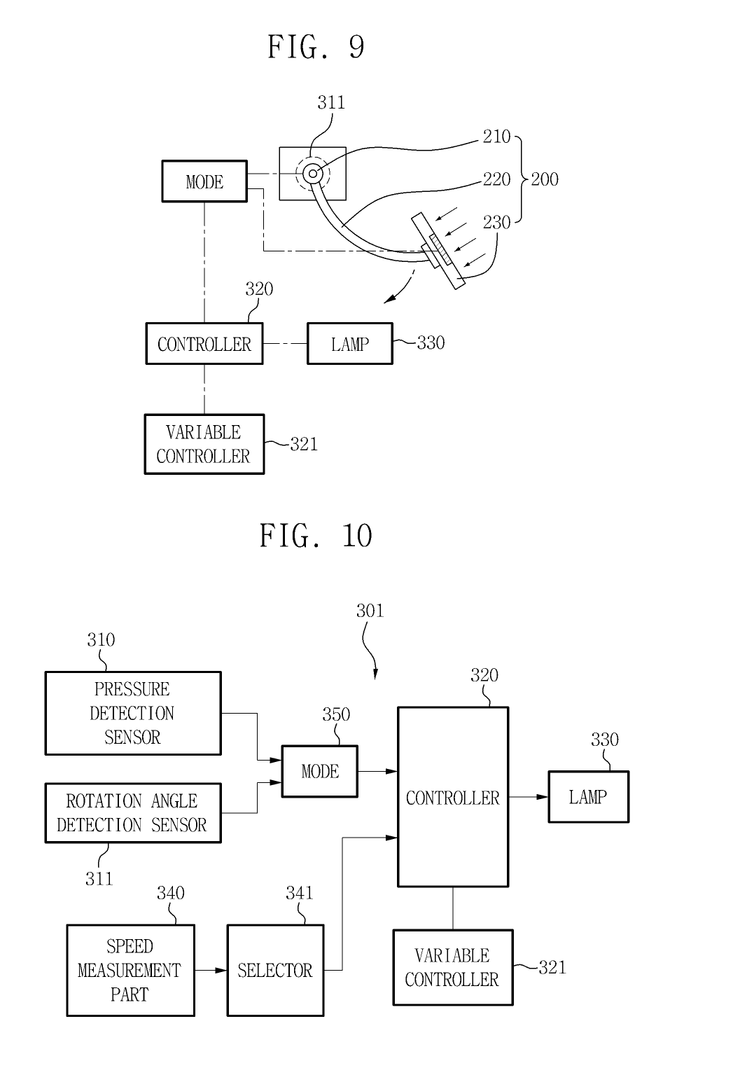

FIG. 9 is a view illustrating an example of a unit for displaying acceleration for a traveling apparatus of the present invention. FIG. 10 is a block diagram illustrating a configuration of the unit for displaying acceleration for a traveling apparatus of FIG. 9.

Next, a unit for displaying acceleration for a traveling apparatus according to still another exemplary embodiment of the present invention will be described below with reference to FIGS. 7 and 8.

The sensor may include the pressure detection sensor 310 installed in the paddle 230 and the rotation angle detection sensor 311 installed on the rotation axis 210. Further, the pressure detection sensor 310 and the rotation angle detection sensor 311 are electrically connected to a mode 350. The mode 350 is electrically connected to the controller 320. One of the pressure detection sensor 310 and the rotation angle detection sensor 311 may operate depending on selection of the mode 350.

Then, the controller 320 is electrically connected to the lamp 330. The controller 320 is electrically connected to the above-described variable controller 321.

Therefore, when one of the pressure detection sensor 310 and the rotation angle detection sensor 311 is selected by the mode 350 to operate, e.g., operation of the pressure detection sensor 310 is selected, the operation may be substantially the same as that described with reference to FIGS. 5 and 6. Alternatively, when operation of the rotation angle detection sensor 311 is selected, the operation may be substantially the same as that described with reference to FIGS. 7 and 8.

As a result, since one of the two sensors 310 and 311 is selected by the mode, when one of the sensors 310 and 311 malfunctions or does not work, the other normal sensor may be used.

Moreover, since the controller 320 may further include a variable controller 321 such as variable resistance, the controller 320 may control an amount of light emission of the lamp 330 to be proportional to the variable rotation angle. For example, when the pressure in the original location of the operating bar 220 is increased, the amount of light emission of the lamp 330 may be increased. Here, since the speed of the traveling apparatus 100 is accelerated depending on degree of a rotation angle or degree of an increase in pressure of the operating bar 220 of the acceleration pedal 200, the amount of light emission of the lamp 330 may represent a speed of the traveling apparatus 100 in an indirect manner.

As a result, other traveling apparatuses traveling behind the rear end of the traveling apparatus 100 may easily and visibly determine whether the traveling apparatus 100 increases speed or not depending on degree of an amount of variable light emission.

Moreover, the controller 320 may be further electrically connected to the selector 341, and the selector 341 may be further connected to a speed measurement part 340.

Here, the speed measurement part 340 may be a speedometer installed in the traveling apparatus 100 such as a car, or a speed measurement program employed by a navigation system.

When use of the speed measurement part 340 is selected by the selector 341, the speed measurement part 340 may transmit a measured traveling speed of the traveling apparatus 100 to the controller 320.

Further, the controller 320 may adjust the amount of light emission of the lamp 330 to be proportional to the traveling speed.

As a result, whether the traveling apparatus 100 increases speed or not may be visibly determined depending on degree of the amount of light emission of the lamp 330 installed at the rear end of the traveling apparatus 100.

Meanwhile, the controller 320 may operate both the pressure detection sensor 310 and the rotation angle detection sensor 311

That is, when pressure is externally applied to the acceleration pedal 200 to rotate the pedal with respect to the rotation axis 210, the pressure detection sensor 310 should transmit variable pressure to the controller 320, and at the same time, the rotation angle detection sensor 311 should transmit a variable rotation angle to the controller 320.

When any one of the variable pressure and the variable rotation angle is not transmitted to the controller 320, the controller 320 selects a sensor from which sensed or detected data are not transmitted to determine it as a sensor in which an abnormality occurs.

Afterwards, the controller 320 may transfer an electric signal to an alarming part (not shown) electrically connected to the controller 320 and installed in a driver's seat of the traveling apparatus 100 to inform the abnormality of the sensor.

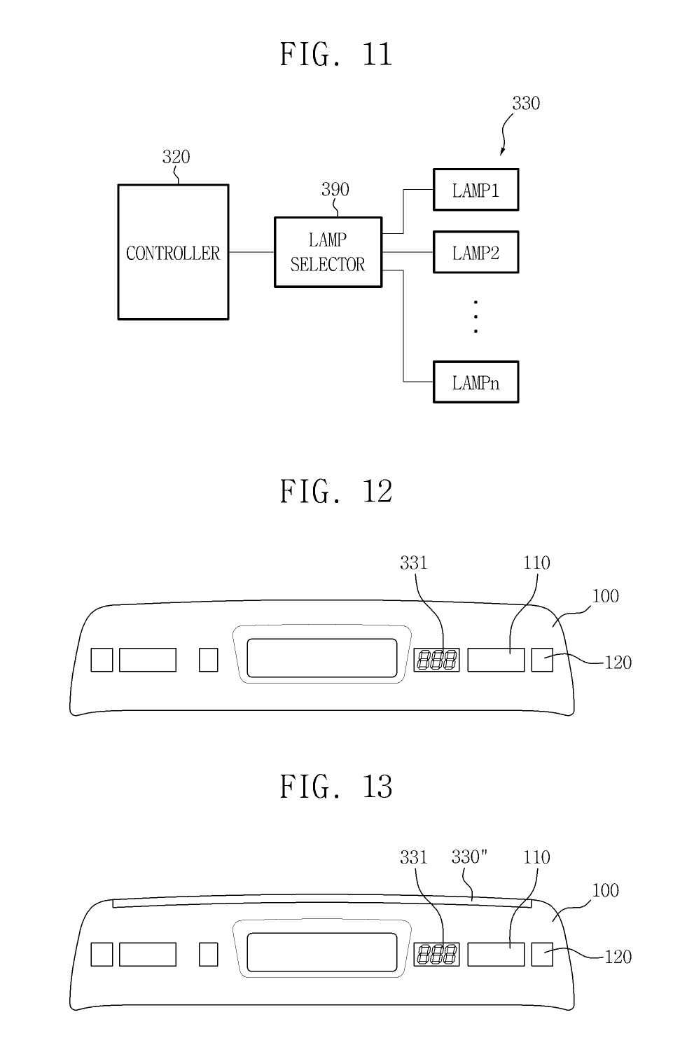

FIG. 11 is a block diagram of a plurality of optionally selected lamps according to the present invention.

Referring to FIG. 11, a lamp 330 according to the present invention may include a plurality of groups consisting of a first lamp, a second lamp, . . . , and an n^{th} lamp to emit light of different colors.

The controller 320 may be further electrically connected to a lamp selecting part 390 optionally selecting one of the plurality of groups. That is, as illustrated in FIG. 11, when the controller 320 is able to optionally select the plurality of lamps, it does not adjust the amount of light emission of the lamp 330 to be proportional to the traveling speed, and selects one of the plurality of groups or the lamp consisting of the plurality of groups via a lamp selector 390, so that whether the traveling apparatus 100 increases speed or not may be visibly determined

FIG. 2 is a view of a rear part of the traveling apparatus of FIG. 1. FIG. 3 is a view illustrating one example of a disposition of a lamp according to the present invention. FIG. 4 is a view illustrating another example of a disposition of a lamp according to the present invention.

As illustrated in FIG. 2, a pair of taillights 110 are disposed on both sides of the rear part of the traveling apparatus 100, and the lamp 330 may be disposed between the pair of taillights 110. Further, turn signal lights 120 are disposed on outward facing sides of the taillights 110.

In addition, referring to FIG. 3, a lamp 330′ may be installed to surround a circumference of the taillight 110. Further, referring to FIG. 4, a lamp 330″ may be disposed over the taillight 110, and may be formed to have a predetermined length in a straight line at a top end of a rear end of the traveling apparatus 100.

The color of emitted light of the lamp 330 described in the present invention may be green. The green is color that is applied to a traffic light, and is easily exposed to views of pedestrians or other drivers. Also, as described above, when the lamp 330 is consisting of a plurality of groups, the color may be consisting of various colors such as green, blue and orange. Further, since the lamp selector 390 is able to select the lamp consisting of one or a plurality of groups, when the groups of the lamp have different emission colors, various emission colors may be shown depending on selection of a group. For example, when the lamp includes three groups, and each group has an emission color corresponding to one of the three primary colors of light, various emission colors in addition to three emission colors corresponding to the three groups may be shown.

FIGS. 12 and 13 are views illustrating a still another example in which a lamp is disposed according to the present invention.

In FIG. 12, a lamp 331 is disposed in a form in which a plurality of lamps are able to display figures. Referring to FIGS. 11 and 12, the controller 320 controls a lamp selector 390 such that a traveling speed of the traveling apparatus 100 that is applied by a speed measurement part 340 to be displayed via the lamp 331. The lamp selector 390 displays the traveling speed of the traveling apparatus 100 using the plurality of lamps 331 depending on control of the controller 320. The lamp 331 of the plurality groups may be disposed to display figures as illustrated in FIG. 12, and the lamp selector 390 may select the lamp of the plurality of groups such that the traveling speed of the traveling apparatus 100 is displayed in figures via the lamp 331 of the plurality groups depending on control of the controller 320.

Therefore, the traveling speed of the traveling apparatus 100 displayed by the lamp 331 at a rear end of the traveling apparatus 100 may be intuitively confirmed, and thus the current speed in addition to presence of acceleration may be exactly determined. As illustrated in FIG. 12, when the lamp 331 installed at the rear end of the traveling apparatus 100 directly displays the traveling speed, other traveling apparatuses may easily recognize the traveling speed of the traveling apparatus 100, and as a result, a safe following distance between traveling apparatuses may be easily ensured.

Further, in the disposition of the lamp of FIG. 12, as one example, the lamp for displaying a traveling speed of the traveling apparatus 100 may be disposed at a location that drivers of other apparatuses may easily recognize in various manners.

As illustrated in FIG. 13, both the lamp 331 of FIG. 12 disposed in a form in which figures can be displayed in addition to the lamp of FIG. 4 may be disposed at the rear end of the traveling apparatus. As described above, the lamp 331 disposed in the form in which figures can be displayed directly displays a traveling speed of the traveling apparatus 100 illustrated in FIG. 12, and thus it may exactly determine the current speed in addition to presence of acceleration. However, drivers of other traveling apparatuses may promptly determine the presence of acceleration of the traveling apparatus rather than an exact traveling speed of the traveling apparatus 100 for safety. Therefore, in FIG. 13, the lamp 330″ of FIG. 4 capable of visibly determining the presence of acceleration from which the traveling speed of the traveling apparatus 100 and the presence of acceleration may be promptly determined by drivers of other traveling apparatuses may be provided as well. In FIG. 13, while it is illustrated that the lamp 331 disposed in a form in which figures can be displayed and the lamp 330″ of FIG. 4 are provided, the lamp 331 disposed in a form in which figures can be displayed and the lamps 330 and 330′ of FIGS. 2 and 3 may be provided. As illustrated in FIG. 13, when both the lamps 330, 330′ and 330″ illustrated in FIGS. 2, 3 and 4 and the lamp 331 disposed in a form in which figures can be displayed are provided, the lamps 330, 330′ and 330″ may be designated as a first lamp, and the lamp 331 may be designated as a second lamp.

In the present invention, when a driver presses an acceleration pedal while driving a traveling apparatus, acceleration of the traveling apparatus can be displayed to the outside to inform the state.

Also, in the present invention, an acceleration state of the traveling apparatus can be informed to other traveling apparatuses following behind a rear end thereof, so that a negligent accident such as a vehicle collision can be prevented in advance.

The foregoing is illustrative of exemplary embodiments and is not to be construed as limiting thereof Although a few exemplary embodiments have been described, those skilled in the art will readily appreciate that many modifications are possible in exemplary embodiments without materially departing from the novel teachings and advantages. Accordingly, all such modifications are intended to be included within the scope of this present invention as defined in the claims. In the claims, means-plus-function clauses are intended to cover the structures described herein as performing the recited function, and not only structural equivalents but also equivalent structures. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A unit for displaying acceleration for a traveling apparatus, comprising:
a sensor installed on an acceleration pedal operating to control a traveling speed of the traveling apparatus, and sensing operation of the acceleration pedal to transmit electric signal to the outside; and
a light emission control module installed in the traveling apparatus, receiving the electric signal from the sensor and controlling light emission of one or a plurality of first lamps installed around taillights of the traveling apparatus,
wherein the acceleration pedal includes a rotation axis installed in the traveling apparatus, an operating bar rotatably connected to the rotation axis, and having one end connected to a throttle valve installed in a power generation engine of the traveling apparatus via a wire, and a paddle installed on the other end of the operating bar, and applied by external power.

2. The unit of claim 1, wherein the light emission control module comprises:
the one or plurality of first lamps disposed between the taillights disposed at both sides of a rear part of the traveling apparatus; and
a controller electrically connected to the one or plurality of first lamps and causing the one or plurality of first lamps to emit light in response to the electric signal output from the sensor.

3. The unit of claim 2, wherein the light emission control module further includes a variable controller controlling the controller to adjust an amount of light emission of the one or plurality of first lamps in response to the electric signal output from the sensor.

4. The unit of claim 2, wherein the light emission control module further includes a speed measurement part installed in the traveling apparatus, measuring a variable traveling speed of the traveling apparatus, and transmitting the results to the controller.

5. The unit of claim 2, wherein the one or plurality of first lamps includes a plurality of groups emitting different lights, and the light emission control module further includes a lamp selector optionally selecting one or a plurality of groups of the plurality groups depending on control of the controller.

6. The unit of claim 5, wherein the light emission control module includes a plurality of second lamps consisting of a plurality of groups such that figures are displayed, and the lamp selector optionally selects one or a plurality of groups of the plurality of groups depending on control of the controller such that the plurality of second lamps display a variable traveling speed of the traveling apparatus in figures.

7. The unit of claim 1, wherein the sensor is installed in the paddle, senses a change in pressure applied to the paddle, and transmits the electric signal.

8. The unit of claim 1, wherein the sensor is a rotation angle detection sensor installed on the rotation axis, sensing a rotation angle of the operating bar, and transmitting the electric signal.
